(19) United States
(12) Patent Application Publication
(10) Pub. No.: US 2018/0047132 A1
(43) Pub. Date: Feb. 15, 2018

(54) DISPLAY CONTROLLER AND OPERATION METHOD THEREOF

(71) Applicant: MStar Semiconductor, Inc., Hsinchu Hsien (TW)

(72) Inventors: Tsung-Chi Lu, Hsinchu Hsien (TW); Tun Chieh Yang, Hsinchu Hsien (TW)

(21) Appl. No.: 15/427,309

(22) Filed: Feb. 8, 2017

Related U.S. Application Data
(60) Provisional application No. 62/374,005, filed on Aug. 12, 2016.

(51) Int. Cl. G06T 1/60; G06F 3/06

(52) U.S. Cl. CPC G06T 1/60; G06F 3/0604; G06F 3/0638; G06F 3/0679; G06F 3/0673

(57) ABSTRACT

A display controller includes a first memory, a second memory and an address controller. The first memory stores first extended display identification data (EDID). The second memory stores second EDID. The address controller sets a predetermined address to one of the first memory and the second memory. The memory set with the predetermined address allows a source device to read the corresponding EDID.

This application claims the benefit of U.S. Provisional Application Ser. No. 62/374,005, filed Aug. 12, 2016, the subject matter of which is incorporated herein by reference.

### BACKGROUND OF THE INVENTION

### Field of the Invention

The invention relates in general to a display controller, and more particularly to a display controller capable of providing extended display identification data (EDID) and an operation method thereof.

### Description of the Related Art

Extended display identification data (EDID) is a set of data defined by the Video Electronics Standard Association (VESA), and is targeted at informing a source device connected to a display device of a capability that the display device provides, e.g., a resolution and a playback frequency of video. The EDID is usually stored in an electrically-erasable programmable read-only memory (EEPROM) coordinating with a display controller. A source device, for example, a personal computer or a multimedia player, may obtain the EDID of the display device through a query and then may provide an appropriate video format for the display device to display. In some circumstances, a display system needs to store a plurality of sets of EDID for a user to choose from. Therefore, how to concisely and effectively respond to a user choice to allow a source device to read the correct set from multiple sets of EDID is essential.

### SUMMARY OF THE INVENTION

It is an object of the present invention to provide a display controller capable of supporting switching among multiple sets of extended display identification data (EDID).

It is another object of the present invention to provide a display controller, which achieves a function of switching EDID without writing an electrically-erasable programmable read-only memory (EEPROM).

It is yet another object of the present invention to provide a display controller, which achieves a function of switching EDID without involving an additional inter-integrated circuit (I²C) bus channel switcher.

A display controller is provided according to an embodiment of the present invention. The display controller includes a first memory, a second memory and an address controller. The first memory stores first EDID. The second memory stores second EDID. The address controller sets a predetermined address to one of the first memory and the second memory. The memory with the set predetermined address allows a source device to read the corresponding EDID.

A display controller is provided according to another embodiment of the present invention. The display controller includes a memory and an address controller. The memory includes a first address interval and a second address interval. The first address interval stores first EDID. The second address interval stores second EDID. The address controller receives an address selection instruction, and selects one of the first address interval and the second address interval to read the corresponding EDID.

A method for providing EDID is provided. The method includes providing a plurality of memories, storing one set of EDID into each of the memories, and setting an address of one of the memories as a slave address of an electrically-erasable programmable read-only memory (EEPROM) defined in an inter-integrated circuit (I²C) bus protocol.

A method for providing EDID is provided. The method includes: providing a static random access memory (SRAM), the SRAM including a plurality of address intervals each storing one set of EDID; and selecting one of the address intervals and reading the corresponding EDID from the selected address interval according to an EDID selection instruction.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a display system according to an embodiment of the present invention;

FIG. 2A is a detailed partial circuit diagram of a display system according to an embodiment of the present invention;

FIG. 2B is a schematic diagram of an EEPROM chip according to an embodiment of the present invention;

FIG. 2C is an address definition table for various devices defined in the I²C bus protocol;

FIG. 2D is a register table for an EEPROM;

FIG. 3 is a block diagram of a display system according to another embodiment of the present invention;

FIG. 4 is a block diagram of a display system according to another embodiment of the present invention;

FIG. 5 is a block diagram of a display system according to another embodiment of the present invention;

FIG. 6 is a flowchart of a method for providing EDID according to an embodiment of the present invention;

FIG. 7 is a flowchart of a method for providing EDID according to another embodiment of the present invention; and

FIG. 8 is a flowchart of a method for providing EDID according to another embodiment of the present invention.

### DETAILED DESCRIPTION OF THE INVENTION

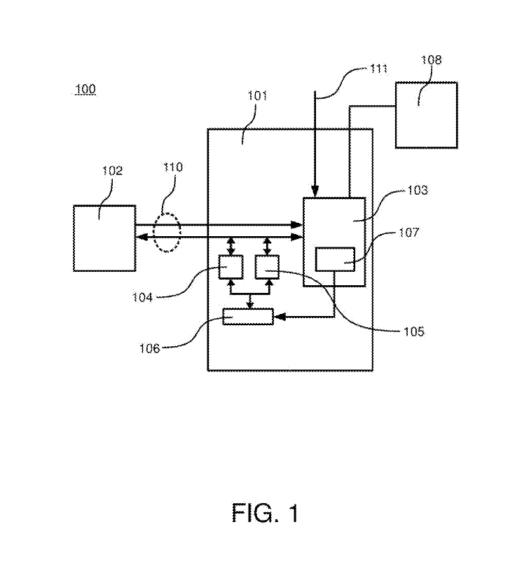

FIG. 1 shows a block diagram of a display system according to an embodiment. Referring to FIG. 1, a display system 100 includes a display controller 101 and a source device 102. The display controller 100 includes a scalar 103, a first memory 104, a second memory 105 and an address controller 106. The address controller 106 is connected to the first memory 104 and the second memory 105. In one embodiment, each of the first memory 104 and the second memory 105 is an electrically-erasable programmable read-only memory (EEPROM). The address controller 106 may set an address of the first memory 104 and may also set an address of the second memory 105. The source device 102 may be a graphic card, a set-top box (STB), a personal computer, or other devices providing video sources. In one embodiment, the display controller 101 is connected to the source device 102 via an inter-integrated circuit (I²C) bus 110. In one embodiment, the I²C bus 110 is connected to the first memory 104 and the second memory 105. In one embodiment, the display system 100 further includes a display device 108 for displaying video or images. The display device 108 is connected to the scalar 103. The source device 102 provides video data, which is transmitted to the scaler 103 and then to the display device 108 for display.

In one embodiment, the scalar 103 includes a controller 107. The controller 107 may be a microcontroller unit (MCU) 107. In one embodiment, the I²C bus 110 is connected to the MCU 107. The first memory 104 stores first extended display identification data (EDID), to be referred to as EDID 1. The second memory 105 stores second EDID, to be referred to as EDID 2. The EDID includes data associated with the resolution and playback frequency of a display device. When the display device is to play video, the source device 102 needs to first obtain the EDID in order to provide appropriate video data. In one embodiment, the display controller 101 needs capabilities of supporting different resolutions and different playback frequencies, and so the display controller 101 needs to provide multiple sets of EDID for the source device 102 to read. In one embodiment, a user may select the required EDID through an external input method. After receiving the selection inputted from the user, the MCU 107 may provide the correct EDID through the address controller 106 for the source device 102 to read. For example, an EDID selection instruction 111 is generated after the user inputs the selection, and the MCU 107 sets a predetermined address with a predetermined definition to the corresponding memory through the address controller 106 according to the EDID selection instruction 111.

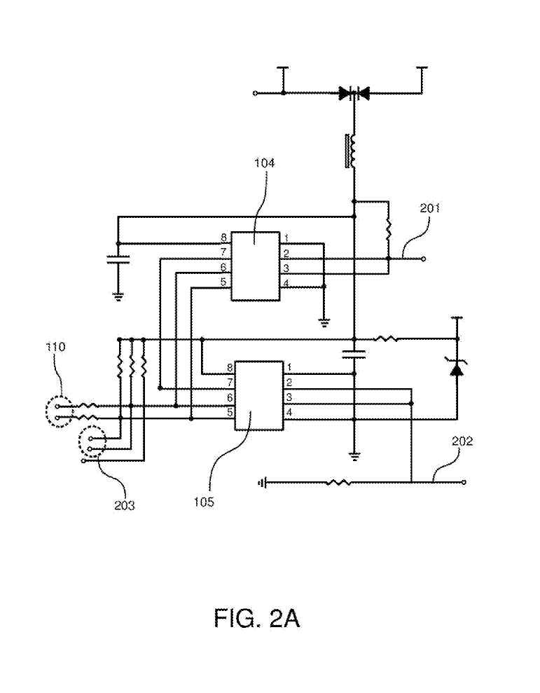

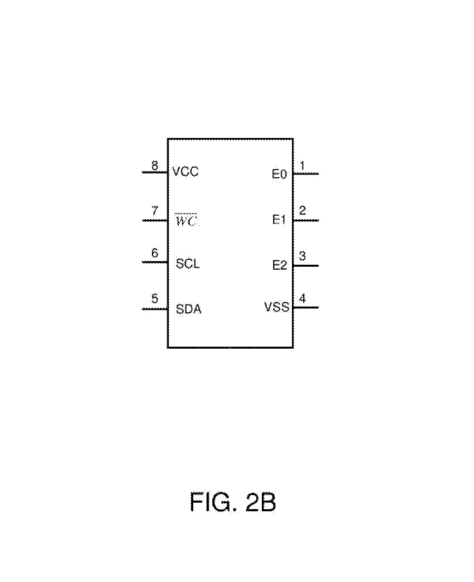

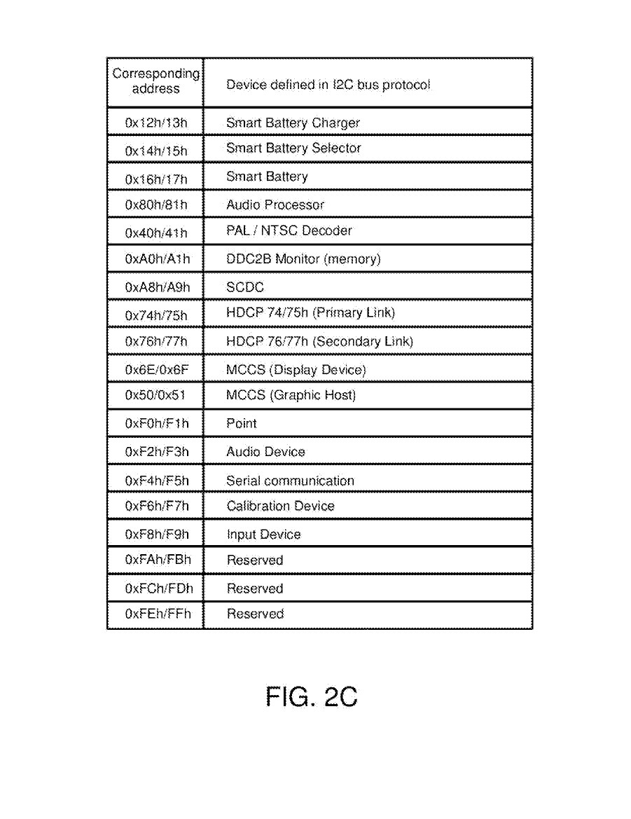

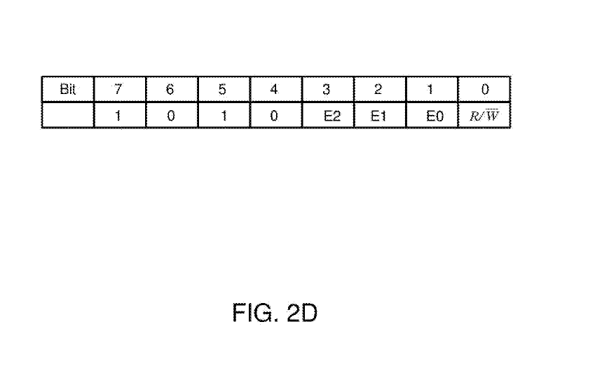

FIG. 2A shows a detailed partial circuit diagram of a display system according to an embodiment, and FIG. 2B shows a schematic diagram of an EEPROM chip according to an embodiment. Referring to FIG. 2A and FIG. 2B, 104 represents a first EERPOM, and 105 represents a second EEPROM. In the embodiment, the first EEPROM 104 and the second EEPROM 105 in FIG. 2A have pin definitions identical to those of the chip in FIG. 2B. For example, pin definitions of pins numbered 1, 2, 3, 4, 5, 6, 7 and 8 of 104 and 105 in FIG. 2A are identical to the pin definitions and pin numbers in FIG. 2B. Each of the EEPROMs includes three inputs E0, E1 and E2. For one EEPROM, EDID stored in this EEPROM is the right one when the three inputs of the EEPROM are at a low level (0). More specifically, if the MCU 107 transits a low-voltage signal (0) to the inputs E1 and E2 of the first EEPROM via a first general purpose input/output (GPIO) port 201 (GPIO pin EDID_SEL_16), and transmits a high-voltage signal (1) to the inputs E1 and E2 of the second EEPROM via a second GPIO port 202 (GPIO pin EDID_SEL_26), the three inputs of the first EEPROM 104 are all at a low level (0). Thus, the EDID stored in the first EEPROM 104 may be normally read by the source device 102, and be regarded as correct EDID by the source device 102. In contrast, the EDID stored in the second EEPROM 105 is not read as the correct EDID by the source device 102. In FIG. 2A, the I²C bus 110 is connected to an I²C bus 203. The I²C bus 110 is externally connected to the source device 102, whereas the I²C bus 201 is connected to the scalar 103. The circuit in FIG. 2A may be realized on one circuit board, and so an additional chip is not required for switching between addresses of EEPROMs.

More specifically, referring to FIG. 2B, the inputs E0, E1 and E2 of the EEPROM are for defining a slave address of the EEPROM. FIG. 2C shows an address definition table for various devices in the I²C bus protocol. FIG. 2D shows a list of registers of an EEPROM. Referring to FIG. 2A to FIG. 2D, when the inputs E0, E1 and E2 are all at a low level (0), a bit value of a register of the EEPROM is A0 or A1, which represent settings for reading and writing, respectively. Further, it also means that the slave address of the EEPROM is 0XA0 or 0XA1. In the I²C bus protocol, 0XA0h and 0XA1h are slave addresses of a memory of a Display Data Channel Standard, Level 2B (DCC2B) monitor. That is to say, when the address is set as 0XA0 or 0XA1, the EDID stored in the EEPROM is considered correct. Thus, the source device 102 may read the correct EDID.

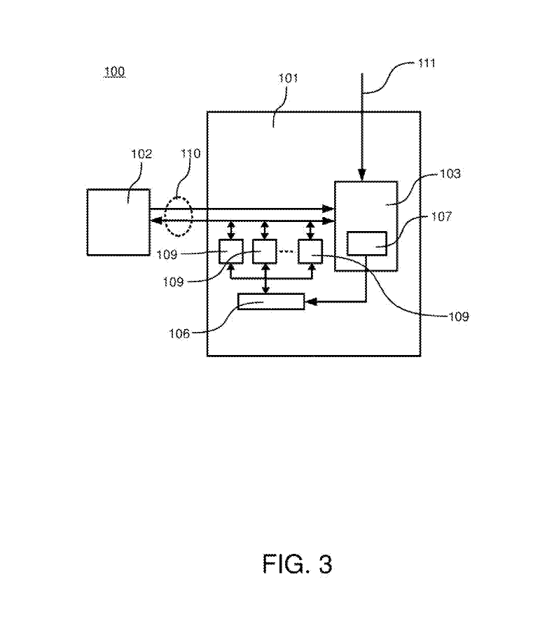

FIG. 3 shows a block diagram of a display device according to another embodiment. Referring to FIG. 3, the display system 100 may include three or more memories 109. Each of the memories 109 is an EEPROM, and stores one set of EDID different from another. When an address of a predetermined EEPROM 109 is set as 0XA0 or 0XA01, the source 102 recognizes this EEPROM 109 and reads the correct the EDID from the EEPROM 109.

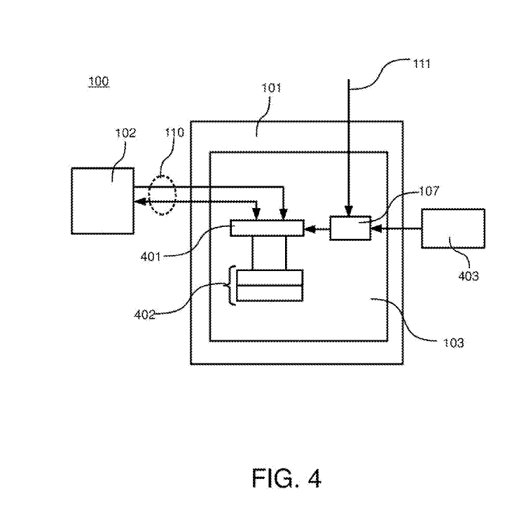

FIG. 4 shows a block diagram of a display device according to another embodiment. Referring to FIG. 4, the display system 100 includes a non-volatile memory 403. In one embodiment, the non-volatile memory 403 is a flash memory. The scalar 103 includes an address controller 401 and a memory 402. In one embodiment, the memory 402 is a static random access memory (SRAM). The memory 402 stores first extended display identification data EDID 1 at a first address interval, and stores second extended display identification data EDID 2 at a second address interval. The first address interval starts at a first starting address EDID 1_S and ends at a first ending address EDID 1_E. The second address interval starts at a second starting address EDID S_2, and ends at a second ending address EDID end_2. Between the first starting address EDID 1_S and the second starting address EDID 2_S is an address offset. The source device 102 is connected to the address controller 401 via the I^{c}2 bus 110. Assuming that the memory 402 is an SRAM 402, when power is disconnected, the EDID 1 and EDID 2 stored in the SRAM 402 vanishes. Thus, once power is restored, the MCU 107 obtains the first extended display identification data EDID 1 and the second extended display identification data EDID 2, and stores the EDID 1 and the EDID 2 to the first address interval and the second address interval of the SRAM 402, respectively. The MCU 107 receives the EDID selection instruction 111, and outputs an address selection instruction. The address controller 106 receives the address selection instruction, and selects the corresponding EDID from one of the first address interval and the second address interval. When the user selects the EDID 1, the address controller 401 provides the EDID 1 stored at the first address interval to the source device 102. When the user selects the EDID 2, the address controller 401 provides the EDID 2 stored at the second address interval to the source device 102.

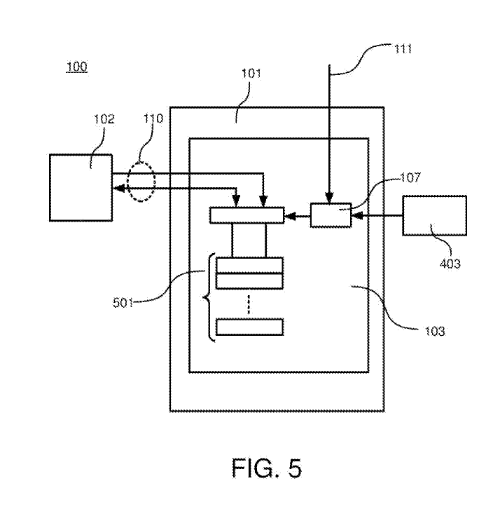

FIG. 5 shows a block diagram of a display system according to another embodiment. Referring to FIG. 5, the display system 100 includes three or more than three address intervals. If the display system 100 needs to support N sets of EDID, N address intervals may be correspondingly arranged in a memory 501 based on requirements to store the N sets of EDID. Operation details of the display system 100 in FIG. 5 are similar to those of the display system in FIG. 4, and shall be omitted herein.

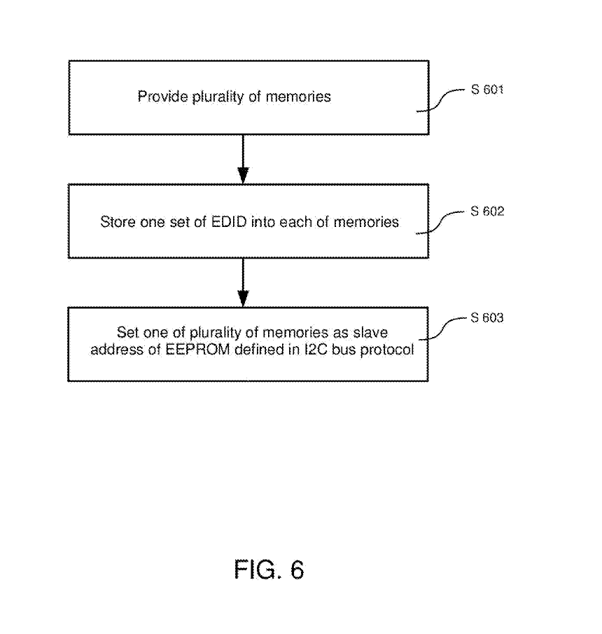

FIG. 6 shows a flowchart of a method for providing EDID. Referring to FIG. 6, a method for providing EDID is provided according to an embodiment of the present invention. First, a plurality of memories are provided (step S601). One set of EDID is stored into each of the memories (step S602). Next, an address of one of the memories is set as a slave address of an EEPROM defined in the I²C bus protocol.

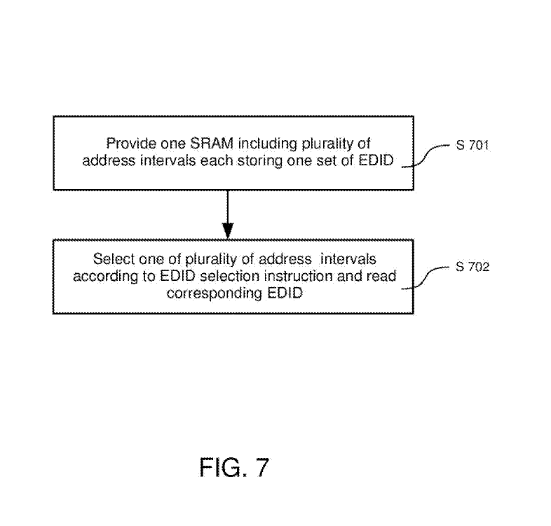

FIG. 7 shows a flowchart of a method for providing EDID. Referring to FIG. 7, a method for providing EDID is provided according to an embodiment of the present invention. First, an SRAM is provided (step S701). The SRAM includes a plurality of address intervals, each storing one set of EDID. Next, one of the address intervals is selected according to an EDID selection, and the corresponding EDID is read from the selected address interval.

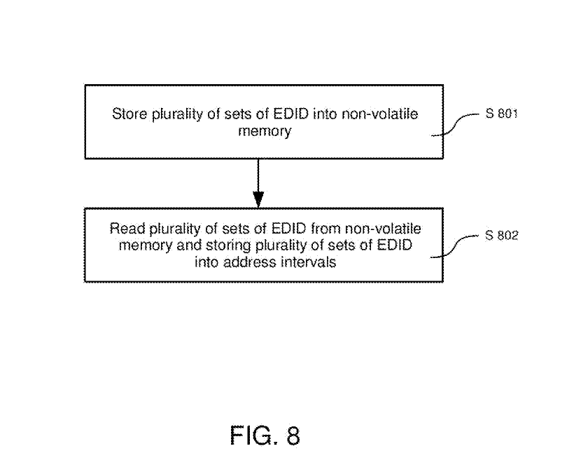

FIG. 8 shows a flowchart of a method for providing EDID. Referring to FIG. 8, the method in FIG. 7 further comprises steps below. The plurality of sets of EDID are stored into a non-volatile memory (step S801). Next, the plurality of sets of EDID is read from the non-volatile memory and stored to the address intervals, respectively (step S802). The steps in FIG. 6, FIG. 7 and FIG. 8 need not be performed in orders shown in the flowcharts; that is, the orders of the steps may be appropriately exchanged by a designer given that the same effect is achieved.

Compared to a conventional approach of providing EDID, the present invention does not need to write correct EDID into an EEPROM nor provide an additional chip that provides EDID in the system, and thus provides outstanding features.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display controller, comprising:
a first memory, storing first extended display identification data (EDID);
a second memory, storing second EDID; and
an address controller, setting a predetermined address to one of the first memory and the second memory, wherein the memory set with the predetermined address allows a source device to read the corresponding EDID.

2. The display controller according to claim 1, further comprising:
a scalar, comprising a microcontroller unit (MCU), the MCU setting the predetermined address through the address controller according to an EDID selection instruction.

3. The display controller according to claim 1, wherein the first memory is an electrically-erasable programmable read-only memory (EEPOMR), and the second memory is an EEPROM.

4. The display controller according to claim 1, wherein the first memory and the second memory are connected to an inter-integrated circuit (I²C) bus.

5. The display controller according to claim 1, further comprising:
a plurality of memories, each storing one set of EDID;
wherein, when the address controller sets the predetermined address to one of the first memory and the second memory, the memory set with the predetermined address allows a source device to read the EDID.

6. A display controller, comprising:
a memory, comprising a first address interval and a second address interval, the first address interval storing first extended display identification data (EDID), the second address interval storing second EDID; and
an address controller, receiving an address selection instruction to select one of the first address interval and the second address interval to read the corresponding EDID.

7. The display controller according to claim 6, wherein the memory is a static random access memory (SRAM).

8. The display controller according to claim 6, further comprising:
a scalar, comprising a microcontroller unit (MCU), the MCU receiving an EDID selection instruction and outputting the address selection instruction.

9. The display controller according to claim 8, further comprising:
a non-volatile memory, storing the first EDID and the second EDID, connected to the MCU;
wherein, when the display controller is enabled, the MCU reads the first EDID and the second EDID from the non-volatile memory and stores the first EDID and the second EDID to the memory.

10. The display controller according to claim 9, wherein the non-volatile memory is a flash memory.

11. The display controller according to claim 6, wherein the address controller is connected to an inter-integrated circuit (I²C) bus, which is for connecting to a source device.

12. The display controller according to claim 6, wherein the memory comprises a plurality of address intervals, to which the first address interval and the second address interval belong, each of the address intervals stores one set of EDID, and the address controller receives an address selection instruction to select one of the plurality of address intervals to read the corresponding EDID.

13. A method for providing extended display identification data (EDID), comprising:
providing a plurality of memories;
storing one set of EDID into each of the memories; and
setting an address of one of the memories as a slave address of an electrically-erasable programmable read-only memory (EEPROM) defined in an inter-integrated circuit (I²C) bus protocol.

14. The method according to claim 13, wherein the plurality of memories are EEPROMs.

15. The method according to claim 13, further comprising:
receiving one set of EDID by a microcontroller unit (MCU), and controlling an address controller to set the slave address according to the EDID selection instruction.

16. A method for providing extended display identification data (EDID), comprising:
providing a static random access memory (SRAM), the SRAM comprising a plurality of address intervals, each of the address intervals storing one set of extended display identification data (EDID); and
selecting one of the address intervals according to an EDID selection instruction and reading the corresponding EDID.

17. The method according to claim 16, further comprising:
storing the plurality of sets of EDID into a non-volatile memory; and
reading the plurality of sets of EDID from the non-volatile memory and storing the plurality of sets of EDID into the address intervals.

18. The method according to claim 16, wherein the step of selecting one of the address intervals and reading the corresponding EDID further comprises:
receiving the EDID by a microcontroller unit (MCU) and outputting an address selection instruction; and
receiving the address selection instruction by an address controller and reading the EDID in the corresponding address interval.
